(19) United States
(12) Patent Application Publication
(10) Pub. No.: US 2008/0314210 A1
(43) Pub. Date: Dec. 25, 2008

(54) Method of making ball-striking faceplate of golf club head

(76) Inventor: Wen-Jen Cheng, Taoyuan City (TW)

Correspondence Address: TROXELL LAW OFFICE PLLC, Suite 1404, 5205 Leesburg Pike, Falls Church, VA, 22041, US

(21) Appl. No.: 11/812,978

(22) Filed: Jun. 22, 2007

(51) Int. Cl. B23B 3/36

(52) U.S. Cl. 82/1.11

(57) ABSTRACT

A method of making a ball-striking faceplate of a golf club head is disclosed, wherein a blank of ball-striking faceplate is coupled to a lathe. The lathe comprises a main shaft and a cutter. The main shaft has a clamping head on one end. A lateral surface of the clamping head is locked onto at least one jig for movably adjusting distance. The method comprises steps of coupling the blank of ball-striking faceplate to the jig, adjusting a distance R between the jig and a center axis of the main shaft, and performing a lathe turning process on the blank of ball-striking faceplate by the lathe according to a route of the cutter, which is pre-set by using a computer for forming longitudinal curvature, transverse curvature and multiple curvatures on the blank of ball-striking faceplate simultaneously and for lathe turning several blanks of ball-striking faceplates simultaneously to increase production efficiency.

### FIELD OF THE INVENTION

The present invention relates to a method of making a ball-striking faceplate of a golf club head, and more particularly to a method designed to form longitudinal curvature, transverse curvature and multiple curvatures on the blank of ball-striking faceplate simultaneously and to lathe several blanks of ball-striking faceplates simultaneously for further increasing production efficiency.

### BACKGROUND OF THE INVENTION

Generally speaking, a ball-striking faceplate of a golf club head is made of metal. Referring to FIG. 1, the ball-striking faceplate 30 has longitudinal and transverse curvatures on the surface. Generally speaking, the ball-striking faceplate of the golf club head is made by casting, forging, or punching method. However, the curvatures formed by using these methods have low precision. A conventional latching method controlled by computer can provide more precise curvatures. However, this kind of latching method can only provide longitudinal curvature and transverse curvature, which are identical to each other.

Referring to FIG. 2, which is a schematic plan view showing a mechanical processing action performed on the ball-striking faceplate by the conventional lathe, wherein the lathe 10 comprises a main shaft 1 and a cutter 2. The main shaft 1 has a clamping head 11 on one end. A jig 12 is locked onto the clamping head 11 for clamping a blank of ball-striking faceplate 20. The main shaft 1 is designed to rotate the clamping head 11, the jig 12 and the blank of ball-striking faceplate 20. The cutter 2 is shiftable along x and y coordinates to lathe turn the blank of ball-striking faceplate 20 for forming identical longitudinal curvature and transverse curvature on the blank of ball-striking faceplate 20.

However, the above-mentioned lathe turning method can only form identical longitudinal curvature z1 and transverse curvature z2. Accordingly, there exists a need to disclose a method to provide the different and precise longitudinal curvature z1 with better performance and the transverse curvature z2 comprising at least one curvature and to lathe turn several blanks of ball-striking faceplates simultaneously.

### SUMMARY OF THE INVENTION

It is an object of the present invention to provide a method of making a ball-striking faceplate of a golf club head, which is able to form longitudinal curvature, transverse curvature and multiple curvatures on the blank of ball-striking faceplate simultaneously and to lathe several blanks of ball-striking faceplates simultaneously for further increasing production efficiency.

In order to achieve the foregoing and other objects, a method of making a ball-striking faceplate of a golf club head is disclosed, wherein a blank of ball-striking faceplate is coupled to a lathe. The lathe comprises a main shaft and a cutter. The main shaft has a clamping head on one end. A lateral surface of the clamping head is locked onto at least one jig for movably adjusting distance. The method comprises steps of coupling the blank of ball-striking faceplate to the jig, adjusting a distance R between the jig and a center axis of the main shaft, and performing a lathe turning process on the blank of ball-striking faceplate by using the lathe according to a route of the cutter, which is pre-set by using a computer for forming longitudinal curvature, transverse curvature and multiple curvatures on the blank of ball-striking faceplate simultaneously and for lathe turning several blanks of ball-striking faceplates simultaneously to increase production efficiency.

### BRIEF DESCRIPTION OF THE DRAWINGS

FIG. 1 is an elevational view showing a golf club head.

FIG. 2 is a schematic plan view showing a mechanical processing action performed on the ball-striking faceplate by the conventional lathe;

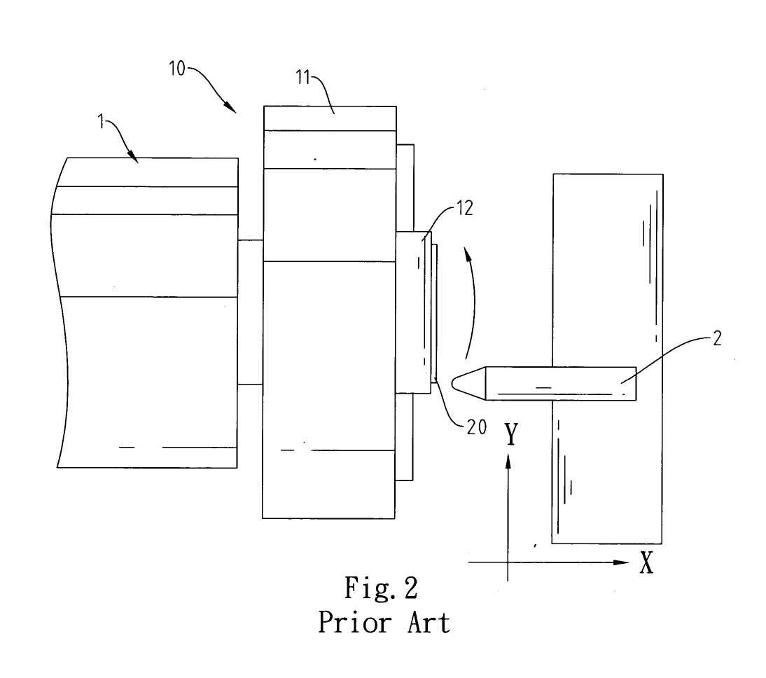

FIG. 3 is a plan view showing the action of the present invention.

FIG. 4 is an elevational view showing the jig of the present invention.

FIG. 5 is a process diagram showing the method of the present invention.

### DETAILED DESCRIPTION OF THE PREFERRED EMBODIMENT

The present inventions discloses a method of making a ball-striking faceplate of a golf club head, which is able to provide longitudinal and transverse curvatures simultaneously by lathe turning process and lathe several blanks of ball-striking faceplates simultaneously for thereby increasing production efficiency.

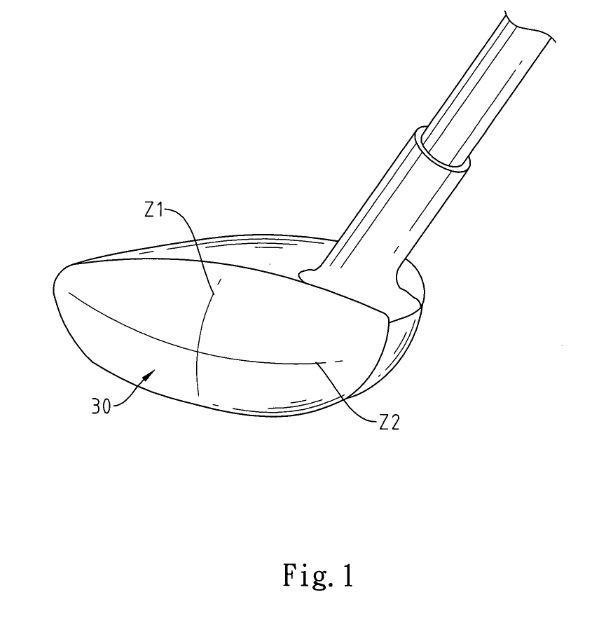

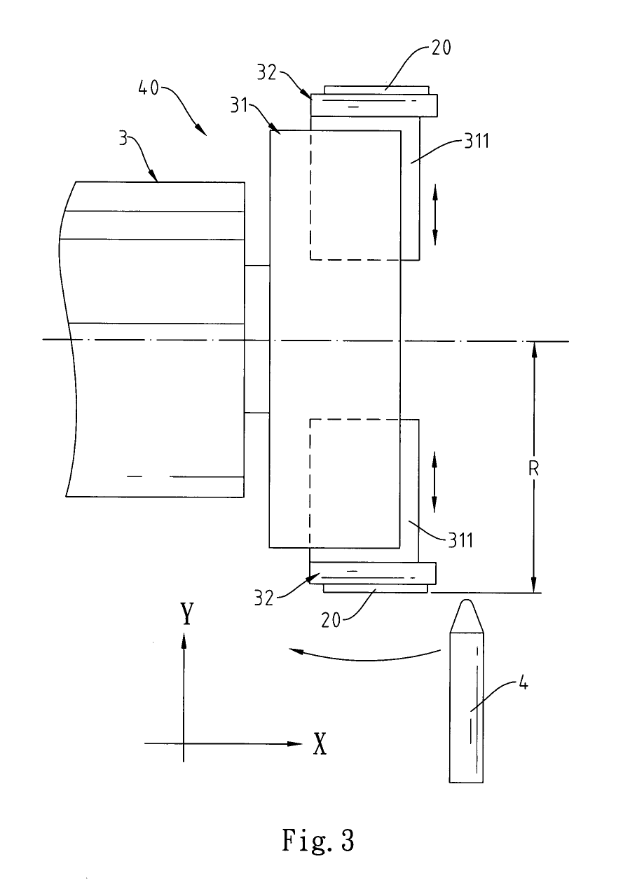

Referring to FIG. 3, a ball-striking faceplate of a golf club head and a lathe 40 utilized in the present invention are shown. The lathe 40 comprises a main shaft 3 and a cutter 4. The main shaft 3 has a clamping head 31 on one end. A jig 32 for movably adjusting distance is locked onto the lateral surface of the clamping head 31. The jig 32 is designed to clamp a blank of ball-striking faceplate 20. The cutter 4 is shiftable along x and y coordinates to lathe turn the blank of ball-striking faceplate 20 for simultaneously forming longitudinal curvature z1 and transverse curvature z2 (shown in FIG. 1).

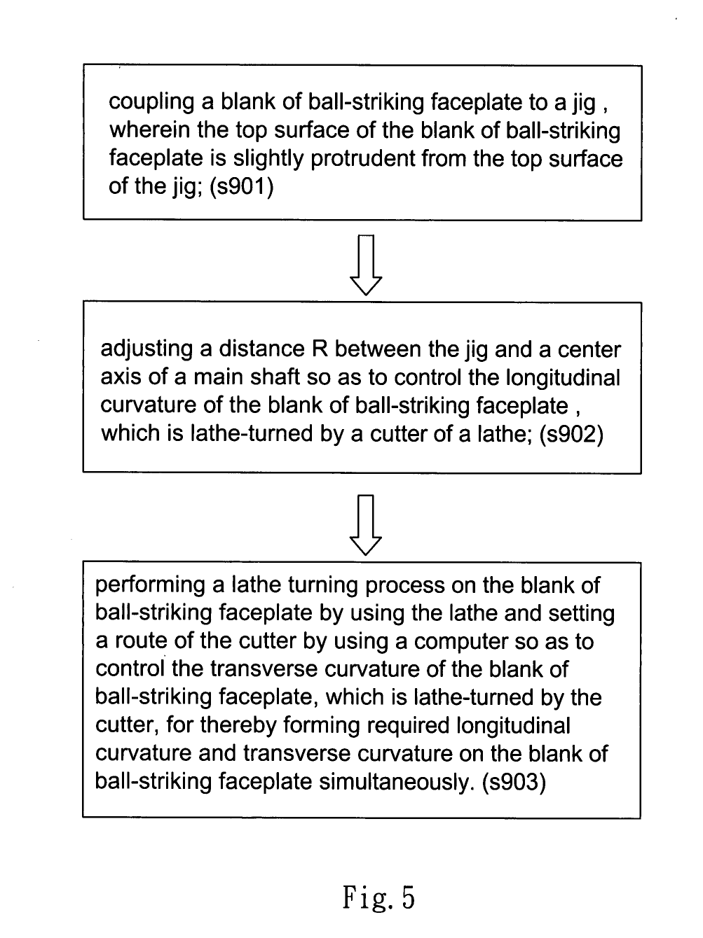

Referring to FIGS. 3 through 5, the method of making the ball-striking faceplate of the golf club head is described. A blank of ball-striking faceplate 20 is coupled to a lathe 40. The lathe 40 comprises a main shaft 3 and a cutter 4. The main shaft 3 has a clamping head 31 on one end. A jig 32 for movably adjusting distance is locked onto the lateral surface of the clamping head 31. The jig 32 is designed to clamp the blank of ball-striking faceplate 20. The above-mentioned method comprises the steps of: a. coupling a blank of ball-striking faceplate 20 to a jig 32, wherein the top surface of the blank of ball-striking faceplate 20 is slightly protrudent from the top surface of the jig 32 (s901); b. adjusting a distance R between the jig 32 and a center axis of a main shaft 3 so as to control the longitudinal curvature z1 (shown in FIG. 1) of the blank of ball-striking faceplate 20, which is lathe-turned by a cutter 4 of a lathe 40 (s902); and c. performing a lathe turning process on the blank of ball-striking faceplate 20 by using the lathe 40 and setting a route of the cutter 4 by using a computer so as to control the transverse curvature z2 (shown in FIG. 1) of the blank of ball-striking faceplate 20, which is lathe-turned by the cutter 4, for thereby forming required longitudinal curvature z1 and transverse curvature z2 (shown in FIG. 1) on the blank of ball-striking faceplate 20 simultaneously (s903).

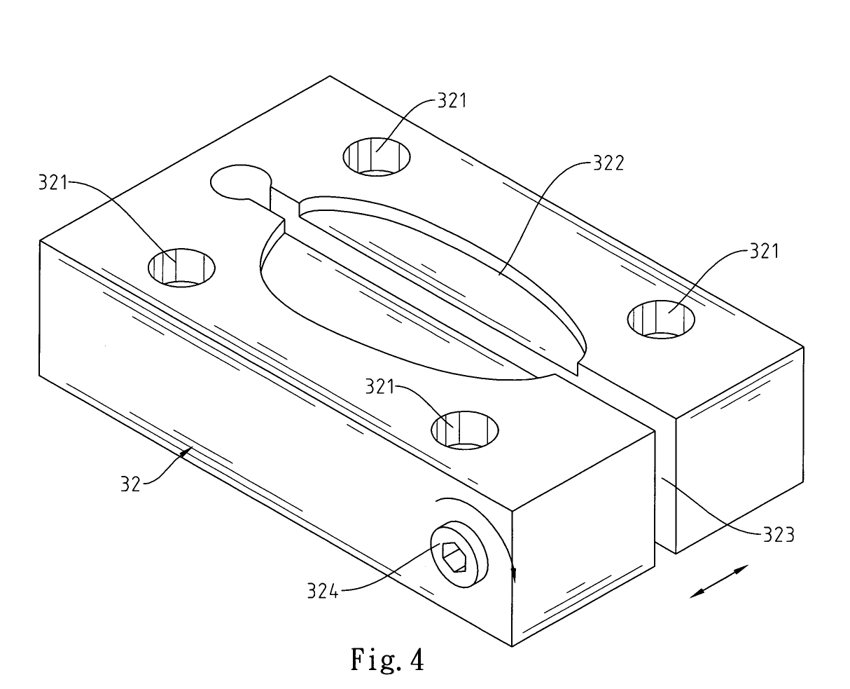

In the above-mentioned method of making the ball-striking faceplate of the golf club head, the jig 32 is mainly designed to couple with the blank of ball-striking faceplate 20. Referring to FIG. 4, a schematic diagram of the jig 32 is shown. The jig 32 has several locking holes 321 for locking the clamping head 31, a trench 322 for coupling with the blank of ball-striking faceplate 20, a slot 323 intersecting the center of the trench 322, and a lock device 324 for adjusting the size of the slot 323. During the use, the jig 32 is locked onto the clamping head 31. In addition, the blank of ball-striking faceplate 20 is held in the trench 322, and the size of the slot 323 is changed by adjusting the lock device 324 for controlling the size of the trench 322 so as to enable the trench 322 to couple with the blank of ball-striking faceplate 20.

Furthermore, a computer is further applied to the above-mentioned manufacture method, wherein the user can write a program according to the required the transverse curvature z2 (shown in FIG. 1) in advance and store this program in the computer so as to enable the computer to control the route of the cutter 4 in step c for thereby obtaining the required transverse curvature z2 (shown in FIG. 1).

It is specially noted that at least one jig 32 is locked onto the lateral surface of the above-mentioned clamping head 31. Certainly, several jigs 32 can all be locked onto the clamping head 31. Generally speaking, referring to FIG. 3, the clamping head 31 has several claws 311 to lock several jigs 32 respectively, wherein these jigs 32 are coupled with the blanks of ball-striking faceplate 20 respectively. As a result, the cutter 4 can form required longitudinal curvature z1 (shown in FIG. 1) and transverse curvature z2 (shown in FIG. 1) on the blanks of ball-striking faceplate 20 simultaneously.

Besides, the above-mentioned transverse curvature z2 (shown in FIG. 1) can be composed of at least one curvature. In other words, the transverse curvature z2 (shown in FIG. 1) can be composed of one or more curvatures.

What the invention claimed is:

1. A method of making a ball-striking faceplate of a golf club head, a blank of ball-striking faceplate being coupled to a lathe, which comprises a main shaft and a cutter, and said main shaft having a clamping head on one end, a lateral surface of said clamping head being locked onto at least one jig for movably adjusting distance, said method comprising:
a. coupling said blank of ball-striking faceplate to said jig so that a top surface of said blank of ball-striking faceplate is slightly protrudent from a top surface of said jig;
b. adjusting a distance R between said jig and a center axis of said main shaft so as to control a longitudinal curvature of said blank of ball-striking faceplate, which is lathe-turned by said cutter; and
c. performing a lathe turning process on said blank of ball-striking faceplate by using said lathe and setting a route of said cutter by using a computer so as to control a transverse curvature of said blank of ball-striking faceplate, which is lathe-turned by said cutter, for thereby forming required longitudinal curvature and transverse curvature on said blank of ball-striking faceplate simultaneously.

2. A method of making a ball-striking faceplate of a golf club head according to claim 1, wherein said jig has a plurality of locking holes for locking said clamping head, a trench for coupling with said blank of ball-striking faceplate, a slot intersecting the center of said trench, and a lock device for adjusting the size of said slot.

3. A method of making a ball-striking faceplate of a golf club head according to claim 1, wherein said clamping head has a plurality of claws.

4. A method of making a ball-striking faceplate of a golf club head according to claim 1, wherein said transverse curvature is composed of one curvature.

5. A method of making a ball-striking faceplate of a golf club head according to claim 1, wherein said transverse curvature is composed of a plurality of curvatures.
